(19) United States
(12) Patent Application Publication
(10) Pub. No.: US 2014/0320048 A1
(43) Pub. Date: Oct. 30, 2014

(54) System and Method for Reducing Radiated Emissions in an Integrated Motor Drive

(71) Applicant: ROCKWELL AUTOMATION TECHNOLOGIES, INC., Mayfield Heights, OH (US)

(72) Inventors: Zoran Vrankovic, Greenfield, WI (US); Rongjun Huang, Saint Louis, MO (US); Mark Cooper, Eden Prairie, MN (US)

(73) Assignee: Rockwell Automation Technologies, Inc., Mayfield Heights, OH (US)

(21) Appl. No.: 13/870,550

(22) Filed: Apr. 25, 2013

(51) Int. Cl. H02K 11/02; H02P 6/14

(52) U.S. Cl. CPC H02K 11/02; H02P 6/14
USPC 318/400.25

(57) ABSTRACT

A motor drive, configured to be mounted to a motor, includes improvements to input circuits configured to receive and/or transfer power within the motor drive to reduce emissions over prior art motor drives. According to a first embodiment of the invention, the motor drive includes a voltage balancing circuit which utilizes surface mount capacitors having a voltage rating of at least 2772 VDC and, preferably, of at least 5000 VDC. According to another embodiment of the invention, the power supply includes a planar transformer wherein the primary and the secondary coils are uniformly formed by traces on the circuit board.

### BACKGROUND OF THE INVENTION

The subject matter disclosed herein relates generally to reducing emissions in a motor drive and, more specifically, to a system for reducing radiated emissions in an integrated motor drive.

As is known to those skilled in the art, motor drives are utilized to control operation of a motor. The motor drive is configured to control the magnitude and frequency of the output voltage provided to the motor to achieve, for example, a desired operating speed or torque. According to one common configuration, a motor drive includes a DC bus having a DC voltage of suitable magnitude from which an AC voltage may be generated and provided to the motor. The DC voltage may be provided as an input to the motor drive or, alternately, the motor drive may include a rectifier section which converts an AC voltage input to the DC voltage present on the DC bus. The motor drive includes power electronic switching devices, such as insulated gate bipolar transistors (IGBTs), thyristors, or silicon controlled rectifiers (SCRs). The motor drive further includes a reverse conduction power electronic device, such as a free-wheeling diode, connected in parallel across the power electronic switching device. The reverse conduction power electronic device is configured to conduct during time intervals in which the power electronic switching device is not conducting. A controller, such as a microprocessor or dedicated motor controller, generates switching signals to selectively turn on or off each power electronic switching device to generate a desired DC voltage on the DC bus or a desired motor voltage.

As is also known, the controller typically utilizes a modulation routine, such as pulse width modulation, to generate the switching signals to control the power electronic switching devices that alternately connect and disconnect the DC bus to one phase of the output to the motor. The modulation routine determines a percentage, or duty cycle, of the duration of one modulation period for which the DC bus is connected to the output. Ideally, when the output is connected to the DC bus, the voltage level on the DC bus is present at the output, and when the output is disconnected from the DC bus, there is zero volts present at the output. Multiplying the voltage level on the DC bus by the duty cycle yields an average value of voltage present at the output during each modulation period. By controlling the duty cycle, the modulation routine controls the average value of voltage present at the output. In addition, if the modulation period is small (i.e., the switching frequency is high) the average value may be controlled to approximate an AC output voltage.

Although the modulation routine converts a DC voltage into an AC voltage, it also generates electrical signals at frequencies other than the desired fundamental frequency of the AC output voltage. The modulation routine generates high frequency square waves having variable duty cycles. A square wave includes harmonic content at various frequencies that are multiples of the switching frequency. Further, the amplitude of the voltage and current conducted through the switching devices may be sizable in comparison, for example, to control signals within the drive or other electronic devices. The motor may require fundamental output voltages having magnitudes, for example, of 230 or 460 V at currents having magnitudes in the amps to hundreds of amps. Although, the magnitude of the harmonic content is a percentage of the fundamental output to the motor, the magnitude of the high frequency signals may still be significant and generate undesirable radiated emissions from the motor drive.

Historically, motor drives have been mounted in control cabinets at a location separated from the motor and/or controlled machine or process on which the motor is installed. Placing the motor drives remotely from the controlled machine or process as well enclosing the motor drive in the control cabinet can each, by themselves, reduce the magnitude of radiated emissions experienced by the controlled machine or process. Additional measures may also be taken at the control cabinet to reduce the radiated emissions from the motor drives. For example, external devices such as ferrite cores and/or EMI filters may be connected to the electrical conductors either providing power to the motor drive or carrying power between the motor drive and the motor in order to reduce the magnitude of these radiated emissions.

However, developments in the power electronic devices used to control the motor have reduced the size of the components. This reduction in size of the power electronic devices along with a desire to reduce the size of the control enclosures have led to mounting at least a portion of the motor drive on the motor itself. However, placing the power electronic switching devices on the motor has drawbacks. The motor drive is no longer remote or isolated from the controlled machine or process. The size of the motor drive is preferably limited to the size of the motor on which it is mounted, which, in turn limits the space available for external, or even internal, devices used to mitigate radiated emissions. Consequently, radiated emissions generated by the motor drive may interfere with other electronic components of the controlled machine or process, including, for example, sensors and communication buses. Thus, it would be desirable to provide a motor drive having reduced emissions for mounting on a motor.

### BRIEF DESCRIPTION OF THE INVENTION

The subject matter disclosed herein describes a motor drive configured to be mounted to a motor. Improvements to input circuits configured to receive and/or transfer power within the motor drive have reduced emissions over prior art motor drives. According to a first embodiment of the invention, the motor drive includes a voltage balancing circuit which utilizes Y2 safety rated surface mount capacitors having a voltage rating of at least 2772 VDC and, preferably, of at least 5000 VDC. According to another embodiment of the invention, the power supply includes a planar transformer wherein the primary and the secondary coils are uniformly formed by traces on the circuit board.

According to one embodiment of the invention, a motor drive is configured to control operation of a motor. The motor includes a rotor, a stator, and a motor housing enclosing the rotor and the stator. The motor drive includes a drive housing mounted to the motor housing, a circuit board, and a DC bus. The circuit board is mounted within the drive housing and has a plurality of layers including a plurality of traces for establishing electrical connections. The DC bus has a first rail and a second rail and is configured to have a DC voltage potential between the first rail and the second rail. A DC bus capacitance is connected between the first rail and the second rail. The motor drive also includes a first capacitor and a second capacitor. The first capacitor has a first terminal and a second terminal and is mounted to the circuit board. The first capacitor is connected via a first trace between the first terminal and the first rail and via a second trace between the second terminal and an earth ground. The second capacitor has a first terminal and a second terminal and is mounted to the circuit board. The second capacitor is connected via a third trace between the first terminal and the earth ground and via a fourth trace between the second terminal and the second rail. Both the first capacitor and the second capacitor have a voltage rating of at least 2772 VDC.

According to another embodiment of the invention, a motor drive is configured to control operation of a motor. The motor includes a rotor, a stator, and a motor housing enclosing the rotor and the stator. The motor drive includes a drive housing mounted to the motor housing, a circuit board, and a DC bus. The circuit board is mounted within the drive housing, has a plurality of layers including a plurality of traces for establishing electrical connections, and an opening extending through the circuit board. The motor drive also includes a ferrite core configured to extend through the opening in the circuit board and an input connector mounted to the drive housing and configured to receive an electrical conductor carrying a voltage at a first voltage potential. A primary coil is defined by at least one of the traces on the circuit board. The trace for the primary coil is located on at least one layer of the circuit board, circumscribes the opening configured to receive the ferrite core, and is electrically connected to the input connector. At least one secondary coil is defined by at least one of the traces on the circuit board. The trace for each of the secondary coils is located on at least one layer of the circuit board and circumscribes the opening configured to receive the ferrite core. At least one tap is electrically connected to the secondary coils such that an additional voltage potential is available at each tap as a function of a turns ratio between the primary coil and the point on the secondary coil at which each tap is electrically connected.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is an exemplary motor control system illustrating a pair of integrated motor drives incorporating the present invention;

FIG. 2 is a schematic representation of the motor control system of FIG. 1;

FIG. 3 is a partial top plan view of a circuit board in one of the integrated motor drives of FIG. 1; and

FIG. 4 is a partial top plan view of a circuit board in one of the integrated motor drives of FIG. 1.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

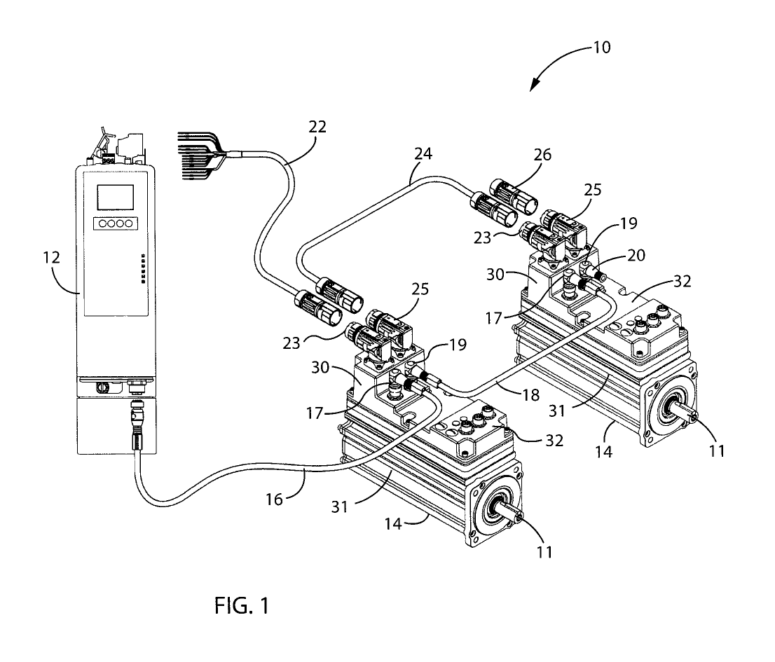

Turning initially to FIG. 1, an exemplary embodiment of a distributed motor control system 10 includes a power interface module 12, a pair of motors 14, and a pair of integrated motor drives 30. It is contemplated that the distributed control system 10 may include various other numbers of motors 14 and integrated motor drives 30. Each motor 14 includes a rotor and a stator contained within the motor housing 31. A drive shaft 11 is operatively coupled to the rotor and extends through an opening in the motor housing 31. Each integrated motor drive 30 includes a housing 32 configured to mount the integrated motor drive 30 to one of the motors 14. Optionally, the motor housing 31 and the drive housing 32 are each a portion of a single housing.

A first communication cable 16 is connected between the power interface module 12 and a first communication connector 17 on the first integrated motor drive 30. A second communication cable 18 connects a second communication connector 19 from the first integrated motor drive 30 to the first communication connector 17 on the second integrated motor drive 30. Similarly, additional second communication cables 18 may be provided to connect additional integrated motor drives 30, if provided, in the distributed motor control system 10. A communications terminating connector 20 is provided on the second communication connector 19 of the final integrated motor drive 30 in the distributed motor control system 10. A first power cable 22 is connected between the power interface module 12 and a first power connector 23 on the first integrated motor drive 30. A second power cable 24 connects a second power connector 25 from the first integrated motor drive 30 to the first power connector 23 on the second integrated motor drive 30. Similarly, additional second power cables 24 may be provided to connect additional integrated motor drives 30, if provided, in the distributed motor control system 10. A power terminating connector 26 is provided on the second power connector 25 of the final integrated motor drive 30 in the distributed motor control system 10. According to various embodiments of the invention, it is contemplated that the first and second communication connectors, 17 and 19 respectively, may be identical connectors, the first and second communications cables, 16 and 18 respectively, may be identical cables of the same or of varying length, the first and second power connectors, 23 and 25 respectively, may be identical connectors, and the first and second power cables, 22 and 24 respectively, may be identical cables of the same or of varying length.

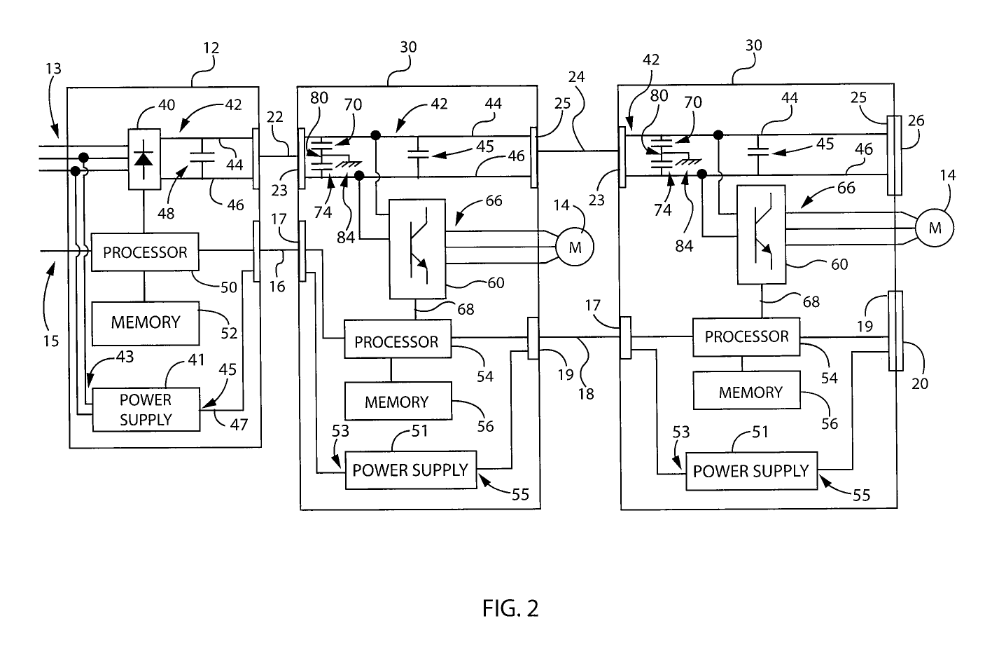

Referring next to FIG. 2, the power interface module 12 includes a rectifier section 40, connected in series between the input voltage 13 and a DC bus 42, and a DC bus capacitor 48 connected across the DC bus 42. It is understood that the DC bus capacitor 48 may be a single capacitor or multiple capacitors connected in parallel, in series, or a combination thereof The DC bus 42 includes a first voltage rail 44 and a second voltage rail 46. Each of the voltage rails, 44 or 46, are configured to conduct a DC voltage having a desired potential, according to application requirements. According to one embodiment of the invention, the first voltage rail 44 may have a DC voltage at a positive potential and the second voltage rail 46 may have a DC voltage at ground potential. Optionally, the first voltage rail 44 may have a DC voltage at ground potential and the second voltage rail 46 may have a DC voltage at a negative potential. According to still another embodiment of the invention, the first voltage rail 44 may have a first DC voltage at a positive potential with respect to the ground potential and the second voltage rail 46 may have a second DC voltage at a negative potential with respect to the ground potential. The resulting DC voltage potential between the two voltage rails, 44 and 46, is the difference between the potential present on the first voltage rail 44 and the second voltage rail 46. According to one embodiment of the invention, the DC bus 42 of the power interface module 12 is connected in series with the DC bus 42 of each of integrated motor drives 30. Electrical connections are established between the respective DC buses 42 via the power cable 22, 24 to transfer the DC bus voltage between devices.

The rectifier section 40 may be either passive or active, where a passive rectifier utilizes electronic devices such as diodes, which require no control signals, and an active rectifier utilizes electronic devices, including but not limited to transistors, thyristors, and silicon controlled rectifiers, which receive switching signals to turn on and off. The power interface module 12 also includes a processor 50 and a memory device 52. It is contemplated that the processor 50 and memory device 52 may each be a single electronic device or formed from multiple devices. Optionally, the processor 50 and/or the memory device 52 may be integrated on a field programmable array (FPGA) or an application specific integrated circuit (ASIC). The processor 50 may send and/or receive signals to the rectifier section 40 as required by the application requirements. The processor 50 is also configured to communicate with external devices via an industrial network 15, including but not limited to, DeviceNet, ControlNet, or Ethernet/IP and its respective protocol. The processor 50 further communicates with other devices within the motor control system 10 via any suitable communications medium, such as a backplane connection or an industrial network, which may further include appropriate network cabling and routing devices.

The power interface module 12 also includes a power supply 41. According to the illustrated embodiment, the power supply 41 has an input 43 connected to one phase of the input voltage 13. Optionally, the input 43 may be configured to receive power from a separate connection to either another AC voltage source or a DC voltage source. The power supply 41 converts the voltage at the input 43 to suitable voltage levels used for control of the electronic devices within the power interface module 12. The power supply 41 also includes an output 45 configured to provide a DC voltage to the integrated motor drives 30 in the distributed motor control system 10. The DC voltage may be, for example, 24 V, 48 V, or any other suitable voltage. An electrical conductor 47 connects the output 45 of the power supply 41 to the connecter for the first communication cable 16. It is contemplated that the electrical conductor 47 may be one or more conductors and may include, but is not limited to, traces on a circuit board, wires, interconnections between conductors, or a combination thereof. According to other embodiments of the invention, the DC voltage may be conducted between devices on the power cable 22 or 24 on a dedicated cable, or on any other suitable electrical conductor connecting the devices.

Each integrated motor drive 30 includes a DC bus 42 connected via a power cable 22 or 24 to either the power interface module 12 or another integrated motor drive 30. Like the power interface module 12, the DC bus 42 on each integrated motor drive 30 includes a first voltage rail 44 and a second voltage rail 46. Each of the voltage rails, 44 or 46, are configured to conduct a DC voltage having a desired potential, according to application requirements. A DC bus capacitor 45 is connected across the DC bus 42. It is understood that the DC bus capacitor 45 may be a single capacitor or multiple capacitors connected in parallel, in series, or a combination thereof According to one embodiment of the invention, the size of the DC bus capacitor 45 in each integrated motor drive 30 is much smaller than the size of the DC bus capacitor 48 in the power interface module 12. It is further contemplated that the DC bus capacitor 48 in the power interface module 12 may be configured to provide sufficient capacitance for the distributed motor control system 10 and, therefore, the DC bus capacitor 45 in each integrated motor drive 30 may be omitted. The DC voltage on the DC bus 42 is converted to an AC voltage by an inverter section, 60. According to one embodiment of the invention, each inverter section 60 converts the DC voltage to a three-phase output voltage available at an output 66 connected to the respective motor 14. The inverter section 60 includes multiple switches which selectively connect one phase of the output to either the first voltage rail 44 or the second voltage rail 46. Each switch may include a transistor and a diode connected in parallel to the transistor. Each transistor receives a switching signal 68 to enable or disable conduction through the transistor to selectively connect each phase of the output 66 to either the first voltage rail 44 or the second voltage rail 46 of the DC bus 42.

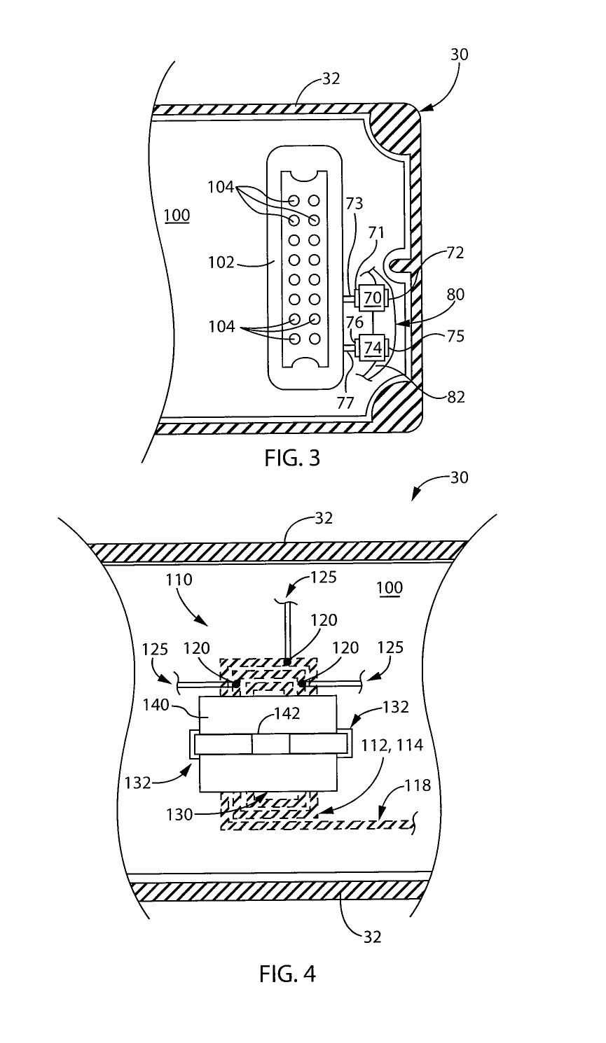

According to the illustrated embodiment, the DC bus 42 carries a first DC voltage at a first potential on the first voltage rail 44 and a second DC voltage at a second potential on the second voltage rail 46, where the second potential is equal in magnitude but opposite in polarity to the first potential. A voltage balancing circuit is included across the DC bus 42 to help maintain the relationship between the first potential and the second potential on each voltage rail 44, 46. The voltage balancing circuit includes a first capacitor 70 and a second capacitor 74. Referring also to FIG. 3, the first capacitor 70 includes a first terminal 71 and a second terminal 72. The first terminal 71 of the first capacitor 70 is connected to the first rail 44, and the second terminal 72 of the first capacitor 70 is connected to a common point 80. The second capacitor 74 includes a first terminal 75 and a second terminal 76. The first terminal 75 of the second capacitor is connected to the common point 80 and the second terminal of the second capacitor 76 is connected to the second rail 46. The common point 80 is connected to an earth ground 84.

In addition to being configured to maintain the relationship between the first and the second potentials on each voltage rail, the voltage balancing circuit is further configured to minimize radiated emissions resulting from the voltage balancing circuit. According to one embodiment of the invention, the first capacitor 70 and the second capacitor 74 are surface mount devices each mounted to a circuit board 100, as illustrated in FIG. 3. A trace 73 extends between the first terminal 71 of the first capacitor 70 to a connector 102 also mounted to the circuit board 100. Similarly, a trace 77 extends between the second terminal 76 of the second capacitor 74 to the connector 102. Pins 104 on the connector 102 are electrically connected to at least one of the power connectors 23 or 25 such that the voltage potential on the DC bus 42 is also present between two pins 104 on the connector 102. Each of the traces 73, 77 between the first capacitor 70 and the second capacitor 74 are electrically connected to one of the pins 104 such that the terminals of the capacitors are connected to either the first rail 44 or the second rail 46 as described above. It is contemplated that various other configurations of establishing electrical connections between the power connectors 23 or 25 and the traces 73 or 77 may be utilized without deviating from the scope of the invention.

A ground trace 82 is run proximate to or under the second terminal 72 of the first capacitor 70 and the first terminal 75 of the second capacitor 74. If the ground trace 82 is configured to run on a top layer of the circuit board 100 it may run adjacent to solder pads configured to receive the respective terminals 72, 75 of the first and second capacitors 70, 74. Optionally, the ground trace 82 may be configured to run on a layer of the circuit board 100 below the top layer and the ground trace 82 may be connected to the solder pads by vias extending through at least a portion of the circuit board 100 to the corresponding layer on which the ground trace 82 is located. The first capacitor 70 and the second capacitor 74 are preferably mounted proximate to each other. Similarly, the first capacitor 70 and the second capacitor 74 are preferably mounted proximate to the connection to the first rail 44 and the second rail 46 of the DC bus 42 as well as to the common point 80. Utilizing surface mount devices and mounting the capacitors proximate to each other as well as proximate to the other connections in the voltage balancing circuit minimizes the potential for radiated emissions to be generated by the voltage balancing circuit.

It is further contemplated that the first capacitor 70 and the second capacitor 74 will be rated for voltages at or above 2772 VDC. According to one embodiment of the invention, the voltage rating for both the first capacitor 70 and the second capacitor 74 is at least 5000 VDC. It is further contemplated that the first capacitor 70 and the second capacitor 74 are Y2 safety rated, meaning that each capacitor is configured to fail in an open, or non-conducting, manner if the capacitor should fail. During manufacture, each integrated motor drive 30 must meet requirements for dielectric strength. Consequently, each of the first rail 44 and the second rail 46 are tested for voltage isolation from earth ground 84. A high voltage potential is connected first to one of the rails 44, 46 and then to the other of the rails 44, 46 to identify potential manufacturing errors that would allow current to conduct between one of the rails 44, 46 and the earth ground 84. However, an integrated motor drive 30 with a voltage balancing circuit has, by design, a conductive path to the earth ground 84 via either the first capacitor 70 or the second capacitor 74. Consequently, a jumper wire is typically installed between the common point 80 and the earth ground 84. During the voltage isolation testing, the jumper wire is removed to break the conductive path. However, during operation of the motor drive, the jumper wire may serve as an antenna for high frequency signals resulting in a source for generating radiated emissions. By using capacitors rated at or above 2772 VDC for the first capacitor 70 and the second capacitor 74, each capacitor 70, 74 is connected to the ground trace 82 directly or by a via extending through a portion of the circuit board 100 to the ground trace 82, eliminating the jumper wire.

Each integrated motor drive 30 also includes a power supply 51. According to the illustrated embodiment, the power supply 51 has an input 53 configured to receive an input voltage from the first communication connector 17. Optionally, the input 53 may be configured to receive power from a separate connection to either an AC or DC voltage source. The power supply 51 converts the voltage at the input 53 to suitable voltage levels used for control of the electronic devices within the integrated motor drive 30. The power supply 51 also includes an output 55 configured to provide a DC voltage to subsequent integrated motor drives 30 in the distributed motor control system 10. The DC voltage may be, for example, 24 V, 48 V, or any other suitable voltage.

Referring next to FIG. 4, the power supply 51 for each integrated motor drive 30 includes a transformer 110 having a primary coil 112 and at least one secondary coil 114. The transformer 110 may include multiple secondary coils 114, multiple taps 120 on a single secondary coil 114, or a combination thereof such that multiple output voltages are present for use within the integrated motor drive 30. Traces 125 extending from each tap supply the various output voltages to different components within the integrated motor drive 30.

The transformer 110 is also configured to reduce emissions from the integrated motor drive 30. At least one opening 130 extends through the circuit board 100. Each opening 130 is configured to receive a portion of a planar core 140. A pair of side openings 132 located to each side of the planar core 140 is configured to receive a clip 142 which extends over and is configured to retain the planar core 140. Optionally, the side openings 132 may be defined in part by one of the openings 130 configured to receive the planar core 140. According to still other embodiments of the invention, other retaining members may be used to hold the planar core 140 within each of the openings 130. Each of the primary and secondary coils 112 and 114, respectively, is defined by one or more traces on the circuit board 100. The primary coil 112 includes an input trace 118 electrically connected to the input 53 of the power supply 51. The primary coil 112 is defined by a trace laid out in multiple loops around the opening 130 on the circuit board 100. As illustrated, the primary coil 112 is made up of generally concentric rectangles looped around the opening 130. Optionally, the primary coil 112 may include multiple traces located on different layers of the circuit board 100 with vias extending between the layers to establish an electrical connection therebetween. At least one secondary coil 114 is similarly defined by a trace laid out in multiple loops around the opening 130 on the circuit board 100. As illustrated, the secondary coil 114 is made up of generally concentric rectangles looped around the opening 130. Each secondary coil 114 is generally aligned with the primary coil 112 but laid out on a layer of the circuit board 100 adjacent to the layer on which the primary coil 112 is located. Optionally, the secondary coil 114 may include multiple traces located on different layers of the circuit board 100 with vias extending between the layers to establish an electrical connection therebetween. It is contemplated that both the primary coil 112 and the secondary coil 114 may be formed from other shapes according to the shape of the planar core 140, opening 130, and other application requirements.

In operation, the power interface module 12 receives an AC input voltage 13 and converts it to a DC voltage with the rectifier section 40. The AC input voltage 13 may be either a three phase or a single phase AC voltage. If the rectifier section 40 is an active rectifier, the processor 50 will receive signals from the active rectifier corresponding to, for example, amplitudes of the voltage and current on the AC input and/or the DC output. The processor 50 then executes a program stored in memory 52 to generate switching signals to activate and/or deactivate the switches in the active rectifier, where the program includes a series of instructions executable on the processor 50. In addition, the switching signals may be generated such that power may be transferred in either direction between the AC input and the DC output. Whether there is a passive rectifier or an active rectifier, the DC bus capacitor 48 connected across the DC bus 42 reduces the ripple resulting from the voltage conversion. The DC voltage is then provided on the DC bus 42 via the first or second power cable 22, 24 between the power interface module 12 and subsequent integrated motor drives 30. The level of DC voltage transferred via the DC bus 42 is typically greater than 50 volts and may be, for example, at least 325 VDC if the AC input voltage 13 is 230 VAC or at least 650 VDC if the AC input voltage 13 is 460 VAC.

The processor 50 of the power interface module 12 may further be configured to communicate with other external devices via the industrial network 15. The processor 50 may receive command signals from a user interface or from a control program executing, for example, on an industrial controller. The command signals may include, but are not limited to, speed, torque, or position commands used to control the rotation of each motor 14 in the distributed motor control system 10. The processor 50 may either pass the commands directly or execute a stored program to interpret the commands and subsequently transmit the commands to each integrated motor drives 30. The processor 50 communicates with the processors 54 of the integrated motor drives 30 either directly or via a daisy chain topology and the first or second communication cables 16, 18. Further, the processor 50 may either communicate using the same network protocol with which it received the commands via the industrial network 15 or convert the commands to a second protocol for transmission to the integrated motor drives 30.

Each integrated motor drive 30 converts the DC voltage from the DC bus 42 to an AC voltage suitable to control operation of the motor 14 on which it is mounted. The processor 54 executes a program stored on a memory device 56. The processor 54 receives a reference signal via the first or second communication cables 16 or 18 identifying the desired operation of the motor 14. The program includes a control module configured to control the motor 14 responsive to the reference signal and responsive to feedback signals such as voltage sensors, current sensors, and/or the angular position sensors mounted to the motor 14. The control module generates a desired voltage reference signal and provides the desired voltage reference signal to a switching module. The switching module uses, for example, pulse width modulation (PWM) to generate the switching signals 68 to control the switches 61 responsive to the desired voltage reference signal.

Each power supply 51 on the integrated motor drives 30 receives the voltage present at the input 53 of the power supply and converts it to suitable control voltages for use within the integrated motor drive 30. The input trace 118 to the primary coil 112 is electrically connected to the input 53 of the power supply. The planar core 140 inductively couples the primary coil 112 to each of the secondary windings 114. The voltage present at each tap 120 is a function of the voltage present on the primary coil 112 and of the turns ratio between the primary coil 112 and the location of the tap 120 on the secondary coil 114. Further, by utilizing traces on the circuit board 100 to define each of the primary coil 112 and the secondary coil 114, greater uniformity in construction of the transformer 110 is achieved. The width of each trace and the overlap between corresponding traces in the primary coil 112 and the secondary coil 114 is more uniform than may be achieved with traditional wire-wound transformers. Consequently, leakage inductance of the transformer 110 is reduced and is more uniform between transformers 110 in different integrated motor drives 30. Thus, the magnitude of leakage current is similarly reduced.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A motor drive configured to control operation of a motor, wherein the motor includes a rotor, a stator, and a motor housing enclosing the rotor and the stator, the motor drive comprising:
a drive housing mounted to the motor housing;
a circuit board mounted within the drive housing having a plurality of layers and including a plurality of traces for establishing electrical connections;
a DC bus having a first rail and a second rail, wherein the DC bus is configured to have a DC voltage potential between the first rail and the second rail;
a DC bus capacitance connected between the first rail and the second rail;
a first capacitor having a first terminal and a second terminal, wherein the first capacitor is mounted to the circuit board and connected via a first trace between the first terminal and the first rail and via a second trace between the second terminal and an earth ground; and
a second capacitor having a first terminal and a second terminal, wherein the second capacitor is mounted to the circuit board and is connected via a third trace between the first terminal and the earth ground and via a fourth trace between the second terminal and the second rail and wherein both the first capacitor and the second capacitor have a voltage rating of at least 2772 VDC.

2. The motor drive of claim 1 wherein both the first capacitor and the second capacitor are Y2 safety rated surface-mount devices.

3. The motor drive of claim 2 wherein the first and the second capacitors are mounted proximate to each other on the circuit board.

4. The motor drive of claim 2 wherein the circuit board further includes:
a ground trace defined on one of the layers and extending below each of first and the second capacitors;
a first electrical connection between the ground trace and the second terminal of the first capacitor; and
a second electrical connection between the ground trace and the first terminal of the second capacitor.

5. The motor drive of claim 2 wherein the motor housing and the drive housing are each a portion of a single housing.

6. The motor drive of claim 2 wherein the circuit board has an opening extending through the circuit board, the motor drive further comprising:
a ferrite core configured to extend through the opening in the circuit board;
an input connector mounted to the drive housing and configured to receive an electrical conductor carrying a voltage at a first voltage potential;
a primary coil defined by at least one of the traces on the circuit board, wherein the trace for the primary coil is located on at least one layer of the circuit board and circumscribes the opening configured to receive the ferrite core and wherein the primary coil is electrically connected to the input connector;
at least one secondary coil, each secondary coil defined by at least one of the traces on the circuit board, wherein the trace for each of the secondary coils is located on at least one layer of the circuit board and circumscribes the opening configured to receive the ferrite core; and
a plurality of taps, each tap electrically connected at a location on one of the secondary coils, wherein an additional voltage potential is available at each tap as a function of a turns ratio between the primary coil and the location on the secondary coil at which each tap is electrically connected.

7. The motor drive of claim 6 wherein the traces of each secondary coil are generally aligned with and located on an adjacent layer to the traces of the primary coil.

8. A motor drive configured to control operation of a motor, wherein the motor includes a rotor, a stator, and a motor housing enclosing the rotor and the stator, the motor drive comprising:
a drive housing mounted to the motor housing;
a circuit board having a plurality of layers mounted within the drive housing including a plurality of traces for establishing electrical connections and an opening extending through the circuit board;
a ferrite core configured to extend through the opening in the circuit board;
an input connector mounted to the drive housing and configured to receive an electrical conductor carrying a voltage at a first voltage potential;
a primary coil defined by at least one of the traces on the circuit board, wherein the trace for the primary coil is located on at least one layer of the circuit board and circumscribes the opening configured to receive the ferrite core and wherein the primary coil is electrically connected to the input connector;
at least one secondary coil, each secondary coil defined by at least one of the traces on the circuit board, wherein the trace for each of the secondary coils is located on at least one layer of the circuit board and circumscribes the opening configured to receive the ferrite core; and
a plurality of taps, each tap electrically connected at a location on one of the secondary coils, wherein an additional voltage potential is available at each tap as a function of a turns ratio between the primary coil and the location on the secondary coil at which each tap is electrically connected.

9. The motor drive of claim 8 wherein the traces of each secondary coil are generally aligned with and located on an adjacent layer to the traces of the primary coil.

10. The motor drive of claim 9 wherein the motor housing and the drive housing are each a portion of a single housing.

11. The motor drive of claim 9 further comprising:
a DC bus having a first rail and a second rail, wherein the DC bus is configured to have a DC voltage potential between the first rail and the second rail;
a DC bus capacitance connected between the first rail and the second rail;
a first capacitor having a first terminal and a second terminal, wherein the first capacitor is mounted to the circuit board and connected via a first trace between the first terminal and the first rail and via a second trace between the second terminal and an earth ground; and
a second capacitor having a first terminal and a second terminal, wherein the second capacitor is mounted to the circuit board and is connected via a third trace between the first terminal and the earth ground and via a fourth trace between the second terminal and the second rail and wherein both the first capacitor and the second capacitor have a voltage rating of at least 2772 VDC.

12. The motor drive of claim 11 wherein both the first capacitor and the second capacitor are Y2 safety rated surface-mount devices.

13. The motor drive of claim 12 wherein the first and the second capacitors are mounted proximate to each other on the circuit board.

14. The motor drive of claim 12 wherein the circuit board further includes:
a ground trace defined on one of the layers and extending below each of first and the second capacitors;
a first electrical connection between the ground trace and the second terminal of the first capacitor; and
a second electrical connection between the ground trace and the first terminal of the second capacitor.
